(19) United States
(12) Patent Application Publication
(10) Pub. No.: US 2010/0171702 A1
(43) Pub. Date: Jul. 8, 2010

(54) SOUNDLESS MOUSE

(75) Inventor: Yu-Chih Cheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/358,960

(22) Filed: Jan. 23, 2009

(30) Foreign Application Priority Data
Jan. 5, 2009 (TW) 098100015

(51) Int. Cl. G06F 3/033

(52) U.S. Cl. 345/163

(57) ABSTRACT

A soundless mouse includes a mouse base, a mouse case, a button, a scroll wheel, a magnetic element, a circuit board, a magnetoresistance sensor and a spring. When the button is clicked, the magnetic element is closed to the magnetoresistance sensor and the magnetoresistance sensor generates an enabling signal to the circuit board. Since the magnetic element is not in direct contact with the magnetoresistance sensor, no clicking noise is generated during operation of the soundless mouse.

### FIELD OF THE INVENTION

The present invention relates to a mouse, and more particularly to a soundless mouse without generating clicking noise during operation.

### BACKGROUND OF THE INVENTION

Due to the amazing power of computer systems, computer systems become essential data processing apparatuses in the digitalized and electronic societies. Input devices such as mice have been widely employed in a computer system for cursor control. Via the mouse, the user may communicate with the computer system. Nowadays, with increasing demand of using the mouse, the mouse having a variety of functions and hardware configurations are designed and the associated technologies is well established in order to meet the users' requirements.

FIG. 1 is a schematic cutaway view of a conventional mouse. As shown in FIG. 1, the mouse 1 principally comprises a mouse base 10, a mouse case 11, two buttons 12, a scroll wheel 14, a circuit board 15 and two micro switches 16. The circuit board 15 is disposed on the mouse base 10. The micro switches 16 are mounted on the circuit board 15. The mouse case 11 is also disposed on the mouse base 10 for sheltering the mouse base 10. The buttons 12 are arranged on the mouse case 11 and over respective micro switches 16. Each button 12 has a triggering part 13. A portion of the scroll wheel 14 is protruded from the outer surface of the mouse case 11 such that the scroll wheel 14 can be rotated by a user's finger. By rotating the scroll wheel 14 of the mouse forwardly or backwardly, the graphic-based window or the web page shown on the computer screen may be scrolled in the vertical direction.

By clicking one of the buttons 12, the triggering part 13 of the button 12 is moved downwardly to trigger corresponding micro switch 16 that is under the clicked button 12. When the micro switch 16 is triggered, the micro switch 16 issues a conducting signal to the circuit board 15. In response to the conducting signal, the circuit board 15 executes a corresponding function.

Hereinafter, the detailed structure of the micro switch will be illustrated as follows with reference to FIG. 2A and FIG. 2B. FIG. 2A is a schematic side view of a conventional micro switch. FIG. 2B is a schematic cutaway view of the conventional micro switch. The micro switch 16 principally includes a switch base 161, a pressing element 168 and an upper cover 162. A perforation 163 is formed in the top cover 162. The micro switch 16 further includes a common terminal 165, a normally open terminal 166, a normally close terminal 164 and a resilient piece 167. The common terminal 165 is disposed on an edge of the base 161. The normally open terminal 166 is disposed on another edge of the base 161. The normally close terminal 164 is disposed beside the normally open terminal 166. The resilient piece 167 has a first end arranged on the common terminal 165. A salient 1671 is formed on a second end of the resilient piece 167. In a case that no external force is exerted on the resilient piece 167, the salient 1671 at the second end of the resilient piece 167 is contacted with the normally close terminal 164. Moreover, the pressing element 168 includes a pressing part 1681 and a protrusion edge 1682. The pressing part 1681 of the pressing element 169 penetrates through the perforation 163 of the upper cover 162, and the protrusion edge 1681 next to the pressing part 1681 is in contact with the periphery of the perforation 163 of the upper cover 162 to prevent the pressing element 168 from gliding out of the perforation 163.

The micro switch 16 is actuated to generate a switching signal by rendering mutual contact between the resilient piece 167, the common terminal 165, the normally open terminal 166 and the normally close terminal 164. In a case that no external force is exerted on the resilient piece 167, the salient 1671 at the second end of the resilient piece 167 is contacted with the normally close terminal 164. Whereas, if the pressing element 168 is clicked by the triggering part 13 (as shown in FIG. 1), the salient 1671 of the resilient piece 167 is separated from the normally close terminal 164 and then contacted with the normally open terminal 166. As such, a loop is collectively defined by the common terminal 165, the resilient piece 167 and the normally open terminal 166. Meanwhile, a conducting signal is generated by the micro switch 16. When the external force is eliminated, the resilient piece 167 returns to its original position and the salient 1671 at the second end thereof will come to contact with the normally close terminal 164 again.

As previously described, when the pressing element 168 is clicked to have the resilient piece 167 come to contact with the normally open terminal 166, a loop is defined and thus a conducting signal is generated. When the external force is eliminated, the restoring force of the resilient piece 167 may push back the pressing element 168 to its original position. During the resilient piece 167 returns to the original position, the salient 1671 on the resilient piece 167 often collides with the normally close terminal 164. Since the salient 1671 and the normally close terminal 164 collide with each other during operation of the micro switch 16, a loud clicking noise is readily generated.

### SUMMARY OF THE INVENTION

It is an object of the present invention to provide a soundless mouse without generating clicking noise during operation.

In accordance with an aspect of the present invention, there is provided a soundless mouse. The soundless mouse includes a mouse base, a mouse case, a button, a magnetic element, a circuit board, a magnetoresistance sensor and a spring. The mouse base is sheltered by the mouse case. The button is disposed on the mouse and has a first surface exposed outside the mouse case to be clicked by a user. The magnetic element is disposed on the button and within the mouse case. The circuit board is disposed on the mouse base. The magnetoresistance sensor is mounted on the circuit board. The spring is arranged between the mouse case and the button and sustained against a second surface of the button for offering an elastic force on the button, thereby permitting upward or downward movement of the mouse case. When the button is clicked to be moved downwardly, the spring is compressed and the magnetic element is closed to the magnetoresistance sensor but spaced from the magnetoresistance sensor, so that the magnetoresistance sensor generates an enabling signal to the circuit board. When the button is not clicked and the spring is stretched, the spring pushes back the button and the magnetic element is moved to be far away the magnetoresistance sensor, so that the magnetoresistance sensor generates a disabling signal to the circuit board.

In an embodiment, the mouse case further includes a perforation and an indentation. The spring is accommodated within the indentation such that the spring is arranged between the mouse case and the button to offer the elastic force on the button.

In an embodiment, the button includes a clicking part, a triggering part and a concave part. The clicking part includes the first surface and the second surface of the button. The first surface of the button is exposed outside the mouse case to be clicked. The triggering part has an end attached on the second surface of the clicking part and the other end penetrating through the perforation such that the triggering part of the button is disposed within the mouse case. The concave part is arranged between the clicking part and the triggering part.

In an embodiment, the clicking part, the triggering part and the concave part are integrated into a one-piece component.

In an embodiment, the magnetic element is disposed on the triggering part of the button.

In an embodiment, the magnetic element is attached on the triggering part of the button by adhesive.

In an embodiment, the magnetic element is a ring-shaped magnet, which is fixed on the triggering part of the button by screwing means.

In an embodiment, the mouse case further includes a stopping part, which is disposed in the vicinity of the perforation and inserted into the concave part. The stopping part is contacted with the bottom of the concave part to obstruct the button from being moved upwardly when the button is moved upwardly, thereby preventing detachment of the triggering part of the button from the mouse case.

In an embodiment, the magnetic element is a magnet.

In an embodiment, the soundless mouse further includes a scroll wheel disposed the mouse case. By rotating the scroll wheel, a graphic-based window or a web page shown on a computer screen is scrolled.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cutaway view of a conventional mouse;

FIG. 2A is a schematic side view of a conventional micro switch;

FIG. 2B is a schematic cutaway view of the conventional micro switch;

FIG. 3 is a schematic cutaway view of a soundless mouse according to a preferred embodiment of the present invention;

FIG. 4 is another schematic cutaway view of the soundless mouse of the present invention;

FIG. 5 is a schematic side view of a soundless mouse according to a preferred embodiment of the present invention; and

FIG. 6 is a schematic cutaway view of a soundless mouse according to another preferred embodiment of the present invention.

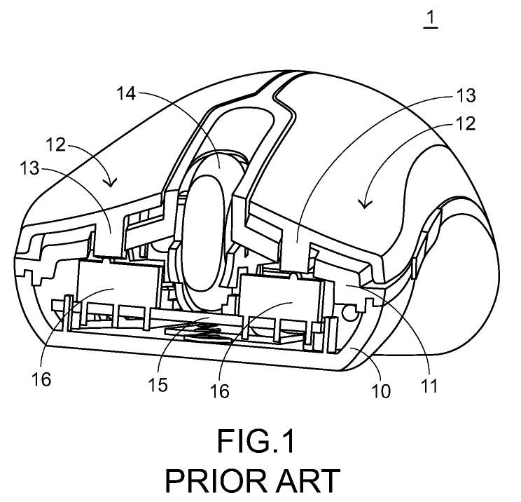

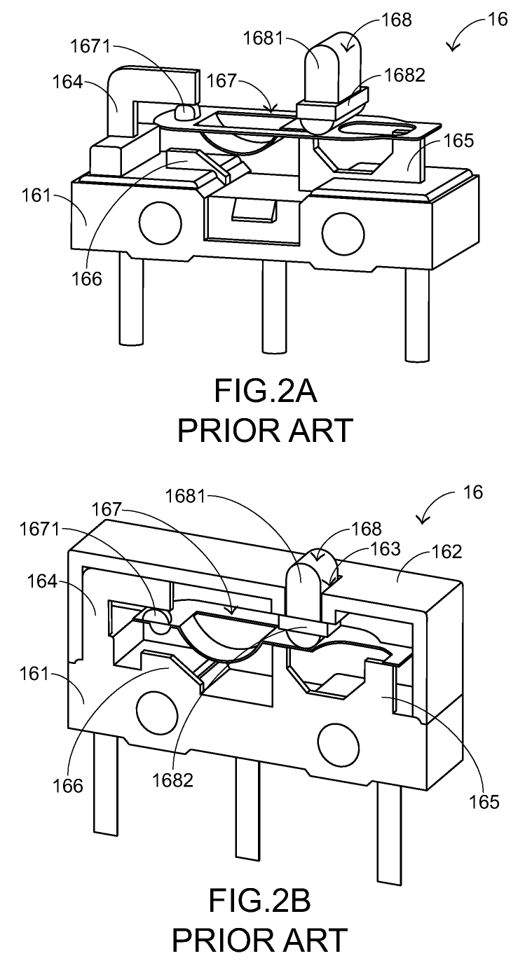

### DETAILED DESCRIPTION OF THE PREFERRED EMBODIMENT

As previously described, a loud clicking noise is readily generated during operation of the conventional mouse. For obviating the drawbacks encountered from the prior art, the present invention relates to a soundless mouse without generating clicking noise during operation.

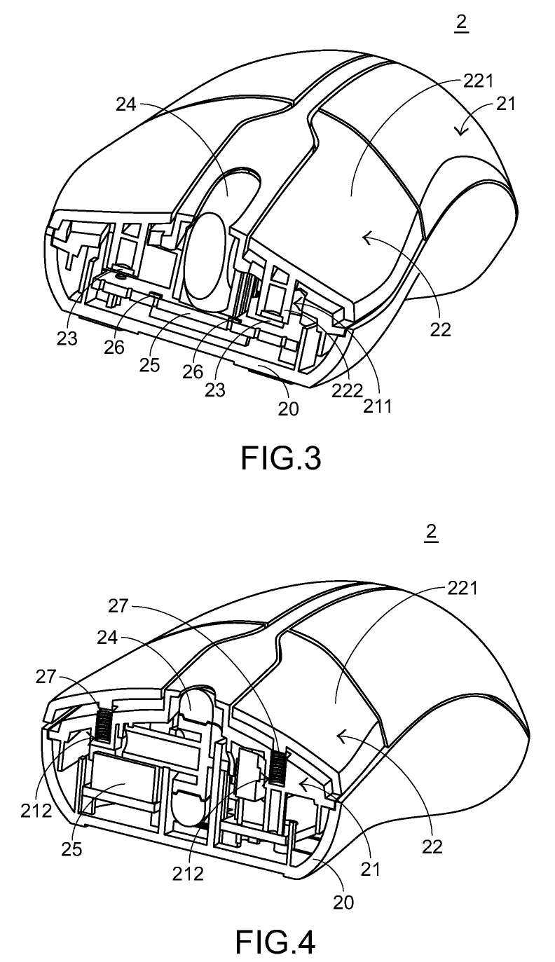

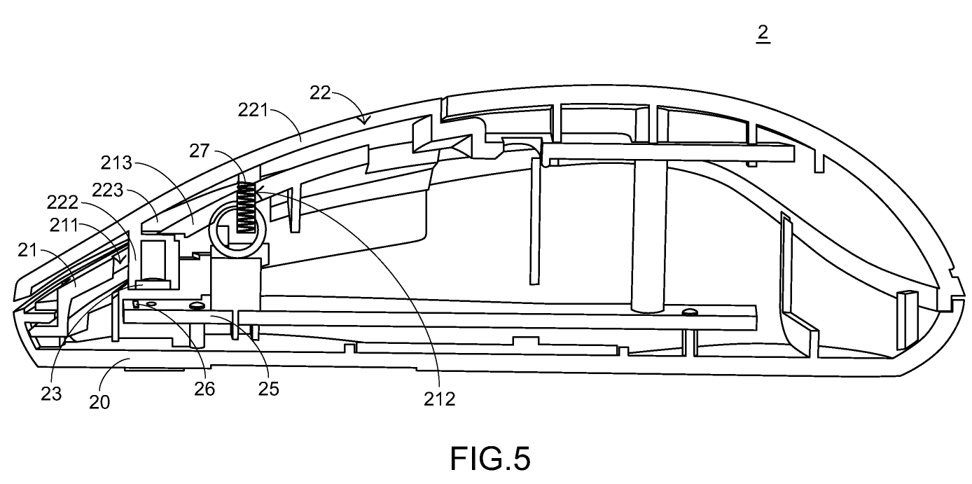

FIG. 3 is a schematic cutaway view of a soundless mouse according to a preferred embodiment of the present invention. FIG. 4 is another schematic cutaway view of the soundless mouse of the present invention. As shown in FIG. 3 and FIG. 4, the soundless mouse 2 principally comprises a mouse base 20, a mouse case 21, two buttons 22, a scroll wheel 24, a circuit board 25, two magnetic elements 23, two magnetoresistance sensors 26 and two springs 27 (also shown in FIG. 4). The circuit board 25 is disposed on the base 20. The magnetoresistance sensors 26 are mounted on the circuit board 25. The mouse case 21 is also disposed on the mouse base 20 for sheltering the mouse base 20. Corresponding to each button 22, the mouse case 21 has a perforation 211 and an indentation 212 (as shown in FIG. 4). The button 22 is disposed on the mouse case 21. The button 22 includes a clicking part 221, a triggering part 222 and a concave part 223 (as shown in FIG. 5). The clicking part 221 of the button 22 has a first surface and a second surface, which are opposed to each other. The first surface of the clicking part 221 is exposed outside the mouse case 21 and thus can be clicked by the user. The triggering part 222 has an end attached onto the second surface of the clicking part 221 and the other end penetrating through the perforation 211 of the mouse case 21. That is, the triggering part 222 of the button 22 is disposed within the mouse case 21. The concave part 223 will be illustrated later.

Please refer to FIG. 3 again. The magnetic element 23 is disposed on the triggering part 222 of the button 22. It is preferred that the magnetic element 23 is attached on the triggering part 222 by adhesive. An example of the magnetic element 23 is a magnet. In a case that the button 22 has not been clicked, the magnetic element 23 is spaced from the magnetoresistance sensor 26 by a first distance, which is greater than a critical distance. If the distance between the magnetic element 23 and the magnetoresistance sensor 26 is greater than the critical distance, the magnetic field of the magnetic element 23 fails to be detected by the magnetoresistance sensor 26. Whereas, if the distance between the magnetic element 23 and the magnetoresistance sensor 26 is smaller than the critical distance, the magnetic field of the magnetic element 23 is detectable by the magnetoresistance sensor 26.

A portion of the scroll wheel 24 is protruded from the outer surface of the mouse case 21 such that the scroll wheel 24 can be rotated by a user's finger. By rotating the scroll wheel 24 of the soundless mouse 2 forwardly or backwardly, the graphic-based window or the web page shown on the computer screen may be scrolled in the vertical direction. The operation principles of the scroll wheel 24 are known in the art, and are not redundantly described herein. As shown in FIG. 4, the spring 27 is accommodated within the indentation 212 of the mouse case 21 such that the spring 27 is arranged between the mouse case 21 and the button 21. Since the spring 27 is sustained against the second surface of the clicking part 221 of the button 22, the compressed spring 27 can offer an elastic force on the button 22.

Hereinafter, the operations of the soundless mouse 2 and the relations between respective components of the soundless mouse 2 will be illustrated in more details with reference to FIG. 3 and FIG. 4. For operating the soundless mouse 2, the clicking part 221 of the left or right button 22 is clicked by the user's finger to exerted an external force on the button 22, the triggering part 222 and the clicking part 221 are moved downwardly in response to the external force. As the triggering part 222 is moved downwardly, the spring 27 is compressed by the second surface of the clicking part 221 and the magnetic element 23 attached on the triggering part 222 is also moved downwardly. Under this circumstance, the magnetic element 23 is spaced from the magnetoresistance sensor 26 by a second distance and the magnetic element 23 and the magnetoresistance sensor 26 are not contacted with each other. The second distance is smaller than the critical distance. That is, the magnetic element 23 is located within the sensing range of the magnetoresistance sensor 26. Since the magnetic element 23 is close to the magnetoresistance sensor 26, the magnetic field of the magnetic element 23 is detected by the magnetoresistance sensor 26. As a consequence, the magnetoresistance sensor 26 generates an enabling signal to the circuit board 25. In response to the enabling signal, the soundless mouse 2 executes a corresponding function. Whereas, when the user's finger is detached from the button 22 and the external force exerted on the button 22 is eliminated, the spring 27 is recovered from the compressed state to the stretched state, so that the spring 27 and the button 22 return to their original positions. Under this circumstance, the magnetic element 23 is spaced from the magnetoresistance sensor 26 by the second distance again. Meanwhile, the magnetoresistance sensor 26 generates a disabling signal to the circuit board 25. In response to the disabling signal, the soundless mouse 2 is disabled.

From the above description, the soundless mouse 2 of the present invention can enable or disable the same functions as the conventional micro switch by moving the magnetic element 23 to be close to or far from the magnetoresistance sensor 26. Since the magnetic element 23 is not in direct contact with the magnetoresistance sensor 26, no clicking noise is generated during operation of the soundless mouse 2.

FIG. 5 is a schematic side view of a soundless mouse according to a preferred embodiment of the present invention. For preventing detachment of the button 22 from the mouse case 21 when the spring 27 is recovered from the compressed state to the stretched state, the mouse case 21 of the soundless mouse 2 further comprises a stopping part 213. The concave part 223 of the button 22 is arranged between the clicking part 221 and the triggering part 222. The stopping part 213 of the mouse case 21 is disposed in the vicinity of the perforation 211 and inserted into the concave part 223. When the button 22 is moved upwardly due to the restoring force of the compressed spring 27, the stopping part 213 of the mouse case 21 is contacted with the bottom of the concave part 223 to obstruct the button 22 from being moved upwardly, thereby preventing detachment of the triggering part 222 of the button 22 from the mouse case 21. In this embodiment, the clicking part 221, the triggering part 222 and the concave part 223 of the button 22 are integrated into a one-piece component.

By the way, the critical distance between the magnetic element 23 and the magnetoresistance sensor 26 is dependent on the volume of the magnetic element 23. For example, as the volume of the magnetic element 23 is increased, the magnetic field of the magnetic element 23 is relatively stronger to trigger the magnetoresistance sensor 26 and thus the critical distance needs to be increased. On the contrary, as the volume of the magnetic element 23 is decreased, the critical distance needs to be decreased.

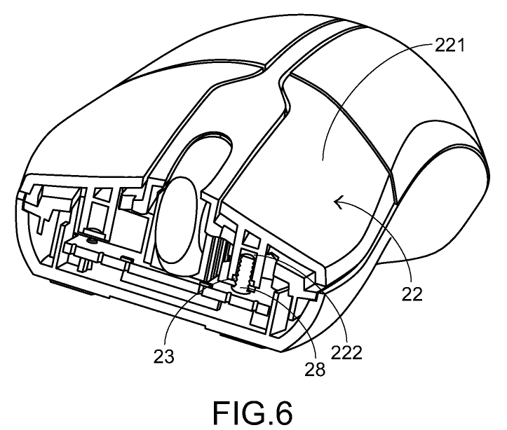

In the above embodiment, the magnetic element 23 is attached on the triggering part 222 by adhesive. It is noted that, however, those skilled in the art will readily observe that the magnetic element 23 may be connected with the triggering part 222 of the button 22 by diverse connecting mechanisms. FIG. 6 is a schematic cutaway view of a soundless mouse according to another preferred embodiment of the present invention. In this embodiment, the mechanism for connecting the button and the magnetic element is distinguished from that shown in FIG. 3. As shown in FIG. 6, the magnetic element 23 is a ring-shaped magnet. A screw 28 is sheathed by the ring-shaped magnet and then screwed in the triggering part 222 of the button 22. That is, the magnetic element 23 is fixed on the triggering part 222 of the button 22 by screwing means. Alternatively, the triggering part 222 of the button 22 may include a hooking structure (not shown) to clamp the magnetic element 23.

From the above description, the soundless mouse of the present invention uses the magnetic element and the magnetoresistance sensor to replace the conventional micro switch. Since the magnetic element is not in direct contact with the magnetoresistance sensor, no clicking noise is generated during operation of the soundless mouse.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A soundless mouse comprising:
a mouse base;
a mouse case for sheltering said mouse base;
a button disposed on said mouse and having a first surface exposed outside said mouse case to be clicked by a user;
a magnetic element disposed on said button and within said mouse case;
a circuit board disposed on said mouse base;
a magnetoresistance sensor mounted on said circuit board; and
a spring arranged between said mouse case and said button and sustained against a second surface of said button for offering an elastic force on said button, thereby permitting upward or downward movement of said mouse case,
wherein when said button is clicked to be moved downwardly, said spring is compressed and said magnetic element is closed to said magnetoresistance sensor but spaced from said magnetoresistance sensor, so that said magnetoresistance sensor generates an enabling signal to said circuit board, and
wherein when said button is not clicked and said spring is stretched, said spring pushes back said button and said magnetic element is moved to be far away said magnetoresistance sensor, so that said magnetoresistance sensor generates a disabling signal to said circuit board.

2. The soundless mouse according to claim 1 wherein said mouse case further comprises a perforation and an indentation, wherein said spring is accommodated within said indentation such that said spring is arranged between said mouse case and said button to offer said elastic force on said button.

3. The soundless mouse according to claim 2 wherein said button comprises:
a clicking part comprising said first surface and said second surface of said button, wherein said first surface of said button is exposed outside said mouse case to be clicked;
a triggering part having an end attached on said second surface of said clicking part and the other end penetrating through said perforation such that said triggering part of said button is disposed within said mouse case; and
a concave part arranged between said clicking part and said triggering part.

4. The soundless mouse according to claim 3 wherein said clicking part, said triggering part and said concave part are integrated into a one-piece component.

5. The soundless mouse according to claim 3 wherein said magnetic element is disposed on said triggering part of said button.

6. The soundless mouse according to claim 5 wherein said magnetic element is attached on said triggering part of said button by adhesive.

7. The soundless mouse according to claim 5 wherein said magnetic element is a ring-shaped magnet, which is fixed on said triggering part of said button by screwing means.

8. The soundless mouse according to claim 3 wherein said mouse case further comprises a stopping part, which is disposed in the vicinity of said perforation and inserted into said concave part, wherein said stopping part is contacted with the bottom of the concave part to obstruct said button from being moved upwardly when said button is moved upwardly, thereby preventing detachment of said triggering part of said button from said mouse case.

9. The soundless mouse according to claim 1 wherein said magnetic element is a magnet.

10. The soundless mouse according to claim 1 further comprising a scroll wheel disposed said mouse case, wherein a graphic-based window or a web page shown on a computer screen is scrolled by rotating said scroll wheel.
